(19) United States
(12) Patent Application Publication
(10) Pub. No.: US 2011/0260013 A1
(43) Pub. Date: Oct. 27, 2011

(54) BAG MASTER SYSTEM

(76) Inventor: Charles Richardson, Baton Rouge, LA (US)

(21) Appl. No.: 13/092,125

(22) Filed: Apr. 21, 2011

Related U.S. Application Data
(60) Provisional application No. 61/326,704, filed on Apr. 22, 2010.

(51) Int. Cl. B65B 67/04; B23P 19/04

(52) U.S. Cl. 248/99; 29/428; 29/426.1

(57) ABSTRACT

A debris collection device comprising: a graduated columnar member having, a first open end located in a top rim, a second open end located in a bottom rim, an inner surface, and an outer surface. First open end and second open end of the graduated columnar member oppose each other to form a through-hole between the top rim and the bottom rim defined by the inner surface having an inner volume of the graduated columnar member (creating a funnel profile.) The outer surface may comprise a flat portion such that the debris collection device can be laid in a debris collection orientation on a ground surface (parallel to) suitable to convey refuse from the ground surface into the top rim, though the graduated columnar member, and into a flexible bag removably-coupled to the bag holding periphery of the bottom rim to storably-contain said refuse for transport to another location.

### CROSS-REFERENCE TO RELATED APPLICATION

The present application is related to and claims priority from prior provisional application Ser. No. 61/326,704, filed Apr. 22, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of refuge collection and containment and more specifically relates to a debris collection device designed to assist in the efficient collection of debris.

2. Description of the Related Art

In modern consumer societies garbage may be inevitable. Garbage bags have been designed to accommodate trash for ease of disposal into collection points for transfer to landfills. There are many tasks that require garbage bags for cleanup. For example, many individuals use bags to remove leaves and other debris from their yard(s). Additionally, bags may also used to clean up after parades or sporting events. Often the collection of trash into the garbage bags may be inconvenient because the garbage may be located on the ground. Without the assistance of another, the task of collection may be frustrating, messy and time consuming as individuals attempt to hold the bag open while another disposes of the debris. Further, individuals may incur strained backs from bending over to pick up loose refuse. As an alternative individuals are often reduced to using one hand to complete the task, which significantly slows down the process. Garbage cans may be used to hold garbage; however when used for leaf collection or other similar tasks the transfer and filling procedure may be messy and difficult. A viable solution is needed.

Various attempts have been made to solve the above-mentioned problems such as those found in U.S. Pat. Nos. 6,450,461; 5,014,943; 5,588,622; D513,352; 4,659,045; and 733,247. This prior art is representative of refuge collection and containment means. None of the above inventions and patents, taken either singly or in combination, is seen to describe the invention as claimed.

Ideally, a debris collection device should be user-friendly, lightweight, able to be operated by a single individual and yet, would operate reliably and be manufactured at a modest expense. Thus, a need exists for a reliable debris collection device system to avoid the above-mentioned problems.

### BRIEF SUMMARY OF THE INVENTION

In view of the foregoing disadvantages inherent in the known refuge collection and containment art, the present invention provides a novel bag master system. The general purpose of the present invention, which will be described subsequently in greater detail is to provide a debris collection device (system) designed to assist in the efficient collection of debris.

Bag Master is a debris collection device designed to assist in the collection of debris, including garbage, cans, leaves, and the like. The device is ideal for use while doing yard work or when cleaning up after a parade, sports game, party, or other such event. The device effectively eliminates the need to manually hold a flexible bag open while filling it. Further, the bag master is capable of holding the flexible bag upright, saving the user time and effort in cleaning a yard, park, construction site, stadium, parking lot, or other area. It allows the user to complete a task that previously required two individuals.

The present debris collection device as described herein preferably comprises the following components: a graduated columnar member having a funnel-shaped profile (or other in alternate embodiments) including, a first open end located in a top rim comprising a first circumference, a second open end located in a bottom rim comprising a second circumference, an inner surface, and an outer surface.

The first open end and the second open end of the graduated columnar member oppose each other to form a through-hole between the top rim and the bottom rim defined by the inner surface. The inner surface defines an inner volume of the graduated columnar member by which debris such as leaves may be put through into a bag for disposal.

The bottom rim preferably comprises a bag holding periphery (a hump or lip) to hold the flexible bag in place via friction contact force. Further, the bottom rim comprises a second circumference, wherein the first circumference comprises a larger ambit-distance (is larger around the circumference, relatively) than the second circumference. The bag holding periphery is suitable to removably-attach to a 30-gallon or larger, the flexible bag with or without straps or elastic to aid in the securing process to the bag holding periphery.

The top rim further preferably comprises an inclined surface leading into the graduated columnar member providing a ramp for the refuse to inclinably-ingress into the graduated columnar member from the ground surface. (The ramp acts as a built-in dustpan.) Further, the top rim and the bottom rim each preferably comprise a planar surface such that the debris collection device may be set on the ground surface at a perpendicular orientation for ease of storage and other. When the graduated columnar member is coupled to the flexible bag together they comprise a debris collection device assembly which may be set flexible-bag-first on the ground surface at a perpendicular orientation to continue filling the flexible bag with the refuge until the flexible bag is full. In this way the present invention provides efficiency in use since the bags may be more compactly-filled in a timely fashion.

The outer surface preferably comprises a flat portion such that the debris collection device can be laid in a debris collection orientation on a ground surface (or floor or pad or other substantially planar surface) suitable to convey refuse from the ground surface into (through) the top rim, though the graduated columnar member (along its length), and ultimately into a flexible bag (plastic garbage bag or other) removably-coupled to the bag holding periphery of the bottom rim. The flexible bag is used to storably-contain the refuse for transport to another location such as a landfill or compost.

A kit is embodied herein for the bag master system comprising: a debris collection device; a plurality of flexible bags; and a set of user instructions.

In accordance with the embodiments of the present invention a preferred method of use is disclosed herein preferably comprising the steps of: step one coupling a flexible bag to a graduated columnar member of the debris collection device to create a debris collection device assembly; step two laying the debris collection device assembly flat on a ground surface; step three manipulating refuse into the debris collection device assembly; step four standing the debris collection device assembly upright to completely fill the flexible bag with the refuge; and step five uncoupling the flexible bag from the debris collection device assembly and transporting the flexible bag to a refuge disposal location.

The present invention holds significant improvements and serves as a bag master system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Bag Master Systems, constructed and operative according to the teachings of the present invention.

FIG. 1 shows a perspective view illustrating a bag master system in an ‘in-use’ condition according to an embodiment of the present invention.

FIG. 2. is a perspective view illustrating a debris collection device (acting in the capacity of a funnel) of the bag master system according to an embodiment of the present invention.

FIG. 3. is a perspective view illustrating a debris collection device assembly of the bag master system, as used to clean a lawn or other ground surface, according to an embodiment of the present invention.

FIG. 4. is another perspective view illustrating the debris collection device assembly including the debris collection device as coupled to a flexible bag, as used to clean a street surface, the bag master system according to an embodiment of the present invention of FIG. 1.

FIG. 5 is a perspective view illustrating the debris collection device assembly of the Bag master system in a perpendicular orientation according to an embodiment of the present invention of FIG. 1.

FIG. 6. is a flowchart illustrating a method of use according to an embodiment of the present invention of FIGS. 1-5.

The various embodiments of the present invention will hereinafter be described in conjunction with the appended drawings, wherein like designations denote like elements.

### DETAILED DESCRIPTION

As discussed above, embodiments of the present invention relate to refuge collection and containment and more particularly to a debris collection device (system) designed to assist in the collection of debris.

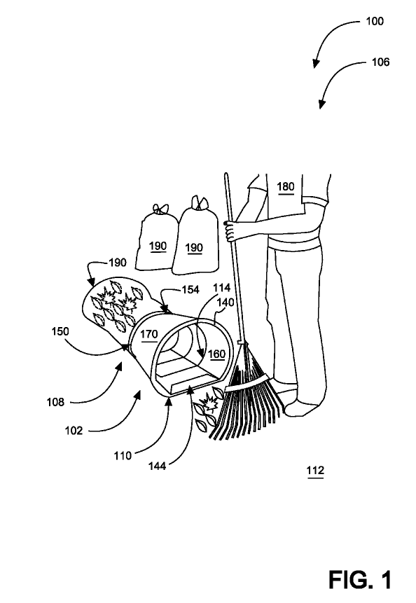

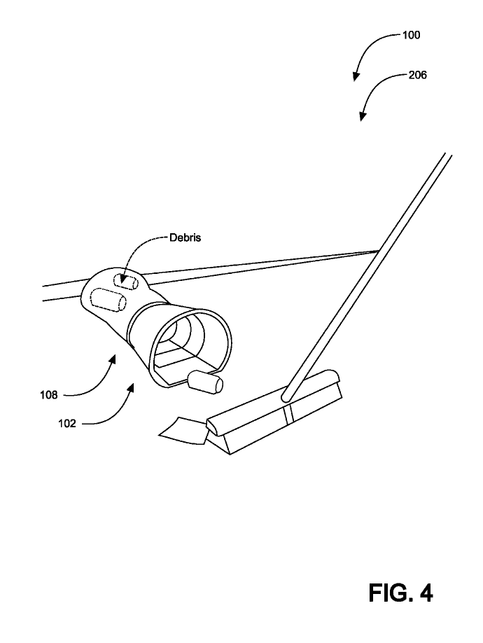

Referring now to FIGS. 1 & 2 showing perspective view of bag master system 100 in ‘in-use’ conditions 106 and 206 (in FIG. 4) according to embodiment(s) of the present invention. Bag master system 100 comprises debris collection device 102, as indicated. Debris collection device 102 preferably comprises a holder for flexible bag(s) 190 designed to assist in the collection of debris, including garbage, cans, leaves, and the like as shown in FIG. 1, however other bags of different material may also be used in conjunction with debris collection device 102. Flexible bag 190 may include a plastic garbage bag or other suitable equivalent such as burlap bags or the like.

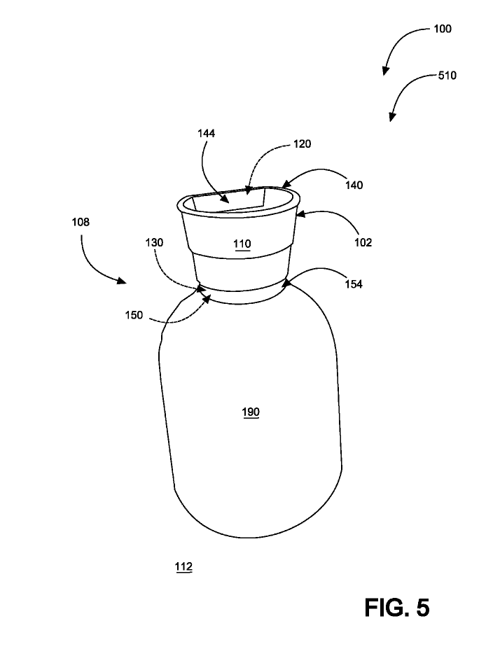

Debris collection device 102 is ideal for use while doing yard work as shown in ‘in-use’ condition 106. However, debris collection device 102 may be used when cleaning up after a parade, sports game, party, or other event as shown in ‘in-use condition 206 of FIG. 4. Debris collection device 102 effectively eliminates the need to manually hold flexible bag 190 open while filling it. In this way debris collection device 102 is operable by a single user 180. Debris collection device 102 preferably is capable of holding flexible bag 190 upright, thereby saving user 180 time and effort in cleaning a yard, park, construction site, stadium, parking lot, or other area as shown in FIG. 5. Further, Debris collection device 102 permits user 180 to complete a task that previously required two individuals. Homeowners, landscapers, and maintenance workers will appreciate the convenience and efficiency of this product.

Debris collection device 102 is preferably made of plastic and may be manufactured in a wide range of colors. Upon reading this specification, it should be appreciated that, under appropriate circumstances, considering such issues as user preferences, design preference, structural requirements, marketing preferences, cost, available materials, technological advances, etc., other material arrangements such as, for example, metal or aluminum, etc., may also be sufficient.

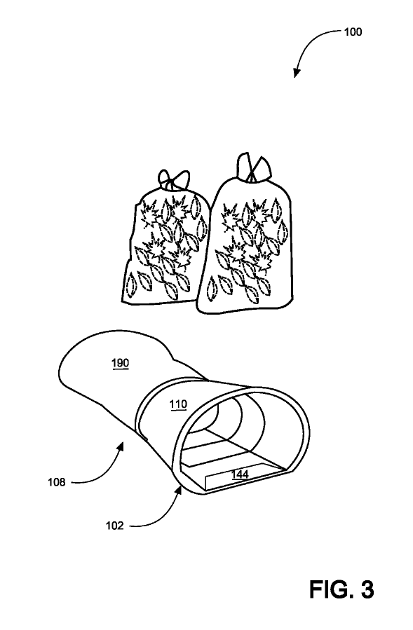

Referring now to FIGS. 3 & 4 showing perspective views of debris collection device 102 of bag master system 100 according to embodiments of the present invention. In certain embodiments, debris collection device 102 can be made to fold flat or made to collapse in order to save space. Debris collection device 102 comprises graduated columnar member 110 which is shown as laid in a position parallel to (flat upon) ground surface 112. Graduated columnar member 110 may comprise either a funnel-shaped profile, a rectangular-shaped profile, an oval-shaped profile, a D-shaped profile, or a half-moon profile. Inclined surface 144 provides an inclined means whereby debris may be swept, raked or the like into the present invention with relative ease. Once flexible bag 190 is attached to graduated columnar member 110 of bag master system 100 (thereby creating debris collection device assembly 108), the user 180 can also scoop debris collection device assembly 108 into the piles of leaves or debris and then place into an upright position (perpendicular orientation 510) and continue to fill.

Graduated columnar member 110 preferably also comprises structural ribs 114 to provide a rigid structure thereby aiding user 180 to enter wastes via various methods into debris collection device 102. In certain alternate embodiments graduated columnar member 110 may collapse (telescope in and out) for storage wherein structural ribs 114 may also act as stops. Additionally, graduated columnar member 110 preferably includes first open end 120, second open end 130, inner surface 160, and outer surface 170. These, in conjunction with each other provide a funnel/tunnel whereby debris may be communicated into flexible bag 190 from ground surface 112. As mentioned previously, ground surface 112 may comprise a floor, street, lawn, pad, deck or other equivalent surface whereupon debris may be found.

First open end 120 is preferably located in top rim 140, (providing an ingress for debris) while second open end 130 is preferably located in bottom rim 150 (providing an ingress for debris into flexible bag 190.) First open end 120 and second open end 130 of graduated columnar member 110 oppose each other to form a through-hole 124 (funneling means) located between top rim 140 and bottom rim 150. Graduated columnar member 110 is defined by first open end 120 and second open end 130 and inner surface 160 thereby permitting refuse to enter and pass through debris collection device 102.

Top rim 140 preferably comprises inclined surface 144 leading into graduated columnar member 110 thereby providing a ramp for refuse to inclinably-ingress into graduated columnar member 110 from ground surface 112. However, top rim 140 may be flat and may not include inclined surface 144 in alternate embodiments. Further, top rim 140 comprises a first circumference suitable for debris ingress (larger than circumference of bottom rim 150.) It should be appreciated that due to the at least one flat side of outer surface 170 that circumference is meant to include circular-shaped and non-circular-shaped profiles (elliptical and/or other non-circular shapes.)

Bottom rim 150 preferably comprises bag holding periphery 154. Bag holding periphery 154 located on bottom rim 150 may comprise a hump to hold flexible bag 190 in place, however, a lip may also be used in other embodiments to hold flexible bag 190 in place. Other means such as clasps, clamps, clips, bands and the like may also be employed. Flexible bag 190 is preferably used to storably-contain the refuse (debris) for transport to another location as mentioned above. Bag holding periphery 154 may be suitable to removably-attach to a refuse-free 30-gallon or larger flexible bag 190. Flexible bag 190 may comprise an elastic band and still be used in conjunction with the present embodiment, the band being fit over the hump, lip or other. Bottom rim 150 comprises a second circumference whereby flexible bag 190 may be secured via, however the first circumference located on top rim 140 preferably comprises a larger ambit-distance than second circumference so that graduated columnar member 110 is indeed graduated and acts in the capacity of a funnel whereby the profile is progressively narrowed.

For flexible bag 190 with straps, a strap tightener may be used to tighten the straps of flexible bag 190 around the hump or lip of debris collection device 102. To tighten the straps of flexible bag 190 around the hump or lip of debris collection device 102 user 180 may pull the straps upward to increase tension around the top of flexible bag 190 by wrapping around and through the tightener thereby securing flexible bag 190 to debris collection device 102. For versions of flexible bag 190 without straps, a durable and high-strength elastic band may be used by placing an open end of flexible bag 190 through the large elastic band and placing the edge of flexible bag 190 in conjunction with the large elastic band (by stretching flexible bag 190) over the lip or the hump of debris collection device 102. A clamp down rim may be used to removably-attach flexible bag 190 onto debris collection device 102, thereby securing flexible bag 190 onto debris collection device 102.

Inner surface 160 preferably defines an inner volume of graduated columnar member 110. Outer surface 170, on the other hand preferably comprises a flat portion such that debris collection device 102 may be laid in a debris collection orientation on ground surface 112 suitable to conveniently convey refuse from ground surface 112 into (through) top rim 140, though graduated columnar member 110, and into flexible bag 190. Flexible bag 190 is preferably removably-coupled to bag holding periphery 154 of bottom rim 150, as described above. In certain embodiments an independent clamp may be used to secure flexible bag 190 to the hump, firmly in place, about the circumference of graduated columnar member 110. The clamp preferably comprises a handle for closing the clamp around the rim; whereby user 180 is able to manipulate the clamp with relative ease. The open end of flexible bag 190 is placed through the clamp and secured to bag holding periphery 154 of bottom rim 150 via the clamping means to form debris collection device assembly 108. Strap-tightener is attached to the Bag Master in alternate embodiments which comprises a biasing element and operates with the draw strings on flexible bag 190 to make them taunt thereby locking flexible bag 190 in place on the hump.

Referring now to FIG. 5 illustration a perspective view illustrating debris collection device 102 of bag master system 100 in perpendicular orientation 510 according to an embodiment of the present invention of FIG. 1. Both top rim 140 and bottom rim 150 each comprise a planar surface such that debris collection device 102 may be set on ground surface 112 at perpendicular orientation 510. Graduated columnar member 110 is coupled to flexible bag 190 to form debris collection device assembly 108 (debris collection device assembly 108 also shown in FIGS. 1 & 3-4 in a parallel position in relation to ground surface 112) which may be set flexible-bag-first on ground surface 112 at a perpendicular orientation to continue filling flexible bag 190 with refuge until flexible bag 190 is full. In this way the present invention allows more efficient use of flexible bag(s) 190.

Bag master system 100 may be sold as kit 550 comprising debris collection device 102; a plurality of flexible bags 190; and a set of user instructions. Flexible bags 190 may be specially designed for use in debris collection device assembly 108.

Bag master system 100 may be manufactured and provided for sale in a wide variety of sizes and shapes for a wide assortment of applications, such as flat on one side, flat on more than one side, oval or cylindrical shaped on some or all of the sides. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

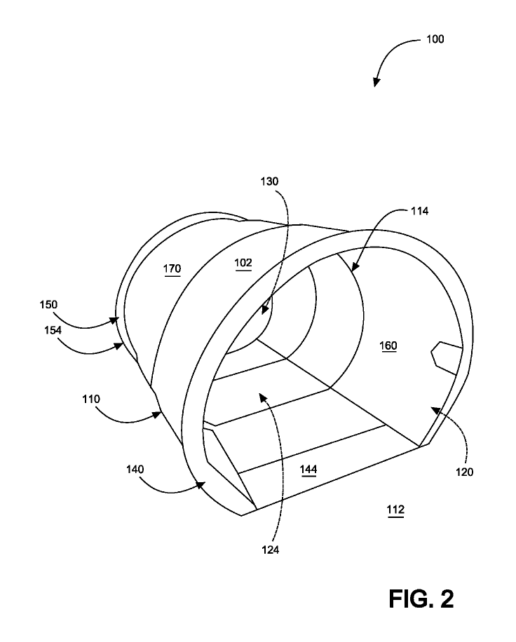

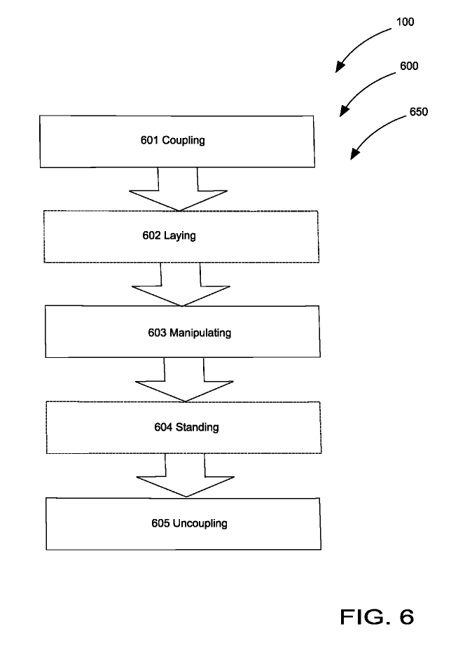

Referring now to FIG. 6. showing a flowchart 650 illustrating a method of use 600 according to an embodiment of the present invention of FIGS. 1-5. FIG. 6. shows a method (at least herein embodying method of use 600) of using debris collection device 102 (to create debris collection device assembly 108) preferably comprises the steps of: step one 601 coupling flexible bag 190 to graduated columnar member 110 of the debris collection device 102 to create a debris collection device assembly 108; step two 602 laying debris collection device assembly 108 flat on (parallel to) a ground surface 112; step three 603 manipulating refuse into debris collection device assembly 108; step four 604 standing debris collection device assembly 108 upright to completely fill flexible bag 190 with the refuge; and step five 605 uncoupling flexible bag 190 from debris collection device assembly 108 and transporting flexible bag 190 to a refuge disposal location.

It should be noted that steps three 602 and step five 604 are optional steps and may not be implemented in all cases. Optional steps of method of use 500 are illustrated using dotted lines in FIG. 5 so as to distinguish them from the other steps of method of use 500.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A debris collection device comprising:
a graduated columnar member having,
a first open end located in a top rim,
a second open end located in a bottom rim,
an inner surface, and
an outer surface,
wherein said first open end and said second open end of said graduated columnar member oppose each other to form a through-hole between said top rim and said bottom rim defined by said inner surface;
wherein said inner surface defines an inner volume of said graduated columnar member;
wherein said bottom rim comprises a bag holding periphery;
wherein said outer surface comprises a flat portion such that said debris collection device can be laid in a debris collection orientation parallel to a ground surface suitable to convey refuse from said ground surface into said top rim, though said graduated columnar member, and into a flexible bag removably-coupled to said bag holding periphery of said bottom rim; and
wherein said flexible bag is used to storably-contain said refuse for transport to another location.

2. The debris collection device of claim 1 wherein said graduated columnar member comprises a funnel-shaped profile.

3. The debris collection device of claim 1 wherein said graduated columnar member comprises a rectangular-shaped profile.

4. The debris collection device of claim 1 wherein said graduated columnar member comprises an oval-shaped profile.

5. The debris collection device of claim 1 wherein said bag holding periphery on said bottom rim comprises a hump to hold said flexible bag in place.

6. The debris collection device of claim 1 wherein said bag holding periphery on said bottom rim comprises a lip to hold said flexible bag in place.

7. The debris collection device of claim 1 wherein said bag holding periphery is suitable to removably-attach to a 30-gallon or larger said flexible bag, said flexible bag without straps.

8. The debris collection device of claim 1 wherein said bag holding periphery is suitable to removably-attach to a 30-gallon or larger said flexible bag, said flexible bag having straps.

9. The debris collection device of claim 1 wherein said bag holding periphery is suitable to removably-attach to a 30-gallon or larger said flexible bag, said flexible bag having an elastic.

10. The debris collection device of claim 1 wherein said top rim comprises an inclined surface leading into said graduated columnar member providing a ramp for said refuse to inclinably-ingress into said graduated columnar member from said ground surface.

11. The debris collection device of claim 1 wherein said top rim and said bottom rim each comprise a planar surface such that said debris collection device may be set on said ground surface at a perpendicular orientation.

12. The debris collection device of claim 1 wherein when said graduated columnar member is coupled to said flexible bag forming a debris collection device assembly which may be set flexible-bag-first on said ground surface at a perpendicular orientation to continue filling said flexible bag with said refuge until said flexible bag is full.

13. The debris collection device of claim 12 wherein said debris collection device assembly is operable by a single individual.

14. The debris collection device of claim 1 wherein said graduated columnar member comprises structural ribs to provide a rigid structure.

15. The debris collection device of claim 1 wherein said top rim comprises a first circumference.

16. The debris collection device of claim 15 wherein said bottom rim comprises a second circumference, wherein said first circumference comprises a larger ambit-distance than said second circumference.

17. A debris collection device comprising:
a graduated columnar member having a funnel-shaped profile including,
a first open end located in a top rim comprising a first circumference,
a second open end located in a bottom rim comprising a second circumference,
an inner surface, and
an outer surface,
wherein said first open end and said second open end of said graduated columnar member oppose each other to form a through-hole between said top rim and said bottom rim as defined by said inner surface;
wherein said inner surface defines an inner volume of said graduated columnar member;
wherein said bottom rim comprises a bag holding periphery;
wherein said bag holding periphery on said bottom rim comprises a hump or lip to hold said flexible bag in place;
wherein said bottom rim comprises a second circumference, wherein said first circumference comprises a larger ambit-distance than said second circumference;
wherein said bag holding periphery is suitable to removably-attach to a 30-gallon or larger said flexible bag, said flexible bag with or without straps or an elastic band;
wherein said top rim comprises an inclined surface leading into said graduated columnar member providing a ramp for said refuse to inclinably-ingress into said graduated columnar member from said ground surface;
wherein said top rim and said bottom rim each comprise a planar surface such that said debris collection device may be set on said ground surface at a perpendicular orientation;
wherein when said graduated columnar member is coupled to said flexible bag forming a debris collection device assembly which may be set flexible-bag-first on said ground surface at a perpendicular orientation to continue filling said flexible bag with said refuge until said flexible bag is full;
wherein said debris collection device assembly is operable by a single individual;
wherein said graduated columnar member comprises structural ribs to provide a rigid structure;
wherein said outer surface comprises a flat portion such that said debris collection device can be laid in a debris collection orientation on a ground surface suitable to convey refuse from said ground surface through said top rim, though said graduated columnar member, and into said flexible bag removably-coupled to said bag holding periphery of said bottom rim; and
wherein said flexible bag is used to storably-contain said refuse for transport to another location.

18. A method for using a debris collection device comprising the steps of:
coupling a flexible bag to a graduated columnar member of said debris collection device to create a debris collection device assembly;
laying said debris collection device assembly flat on a ground surface; and
manipulating refuse into said debris collection device assembly.

19. The method for using a debris collection device of claim 18 further comprising the step of standing said debris collection device assembly upright to completely fill said flexible bag with said refuge.

20. The method for using a debris collection device of claim 19 further comprising the step of uncoupling said flexible bag from said debris collection device assembly and transporting said flexible bag to a refuge disposal location.
